(19) United States
(12) Patent Application Publication
(10) Pub. No.: US 2024/0231860 A1
(43) Pub. Date: Jul. 11, 2024

(54) SYSTEM AND METHOD FOR AUTOMATIC RIGHTSIZING OF CLOUD DESKTOPS BASED ON HISTORICAL PERFORMANCE DATA

(71) Applicant: Workspot, Inc., Campbell, CA (US)

(72) Inventors: Anushree Kunal Pole, Sunnyvale, CA (US); Shiva Prasad Madishetti, Frisco, TX (US); Virabrahma Prasad Krothapalli, San Jose, CA (US); Amitabh Bhuvangyan Sinha, San Jose, CA (US); Jimmy Chang, Mountain View, CA (US); David T. Sulcer, Pacifica, CA (US)

(21) Appl. No.: 18/152,680

(22) Filed: Jan. 10, 2023

Related U.S. Application Data
(60) Provisional application No. 63/376,381, filed on Sep. 20, 2022.

(51) Int. Cl. G06F 9/451; G06F 9/455; G06F 9/50

(52) U.S. Cl. CPC G06F 9/452; G06F 9/45558; G06F 9/5077; G06F 2009/4557; G06F 2009/45591; G06F 2009/45595

(57) ABSTRACT

A system and method for providing computing resources for a virtual desktop system is disclosed. A cloud region provides a virtual desktop to a client device of a user. The virtual desktop has a specification of computing resources provided by the cloud region. A performance analysis service collects operational data from use of the virtual desktop by the user. The performance analysis service analyzes use of the computing resources of the virtual desktop according to utilization ranges relative to the specification. The specification for the virtual desktop is updated based on a comparison of the utilization range and the specification. A control plane is coupled to the cloud region. The control plane adjusts the computing resources of the cloud region for providing the virtual desktop.

### PRIORITY CLAIM

This application claims the benefit of and priority to U.S. Provisional Application No. 63/376,381, filed on Sep. 20, 2022. The entirety of that application is hereby incorporated by reference.

### TECHNICAL FIELD

The present disclosure relates generally to network-based virtual desktop systems. More particularly, aspects of this disclosure relate to a system that efficiently provides virtual desktops to users based on historic performance data.

### BACKGROUND

Computing systems that rely on applications operated by numerous networked computers are ubiquitous. Information technology (IT) service providers thus must effectively manage and maintain very large-scale infrastructures. An example enterprise environment may have many thousands of devices and hundreds of installed software applications to support. The typical enterprise also uses many different types of central data processors, networking devices, operating systems, storage services, data backup solutions, cloud services, and other resources. These resources are often provided by means of cloud computing, which is the on-demand availability of computer system resources, such as data storage and computing power, over the public internet or other networks without direct active management by the user.

Users of networked computers such as in a cloud-based system may typically log into a computer workstation or client device and are provided a desktop application that displays an interface of applications and data available via the network or cloud. Such desktop applications will be initially accessed when a user logs in, but may remain active to respond to user operation of applications displayed on the desktop interface. While users may activate the desktop application on any computer on the network, most users work from one specific computer.

Remote desktop virtualization solutions have been available for over a decade. These solutions provide virtual desktops to network users. In remote desktop virtualization offerings, there is typically a capability of associating a remote desktop virtualization template in a particular cloud region with a remote desktop virtualization pool in the same cloud region as part of the general configuration model. This remote desktop virtualization template is customized with the image of the right desktop for a particular remote desktop virtualization use case.

Companies lose revenue when a user cannot access their cloud desktop because of issues out of their control. There is a need in Cloud based computing to provide a cloud desktop in an optimal fashion as defined by requirements, including but not limited to user experience and costs. When needed, a cloud desktop, in the form of an instantiated virtual machine in a specific cloud region, is made available to the end user, with all necessary state synchronized with any previously instantiated cloud desktop used by the end user, to reliably fulfill the requirements of the user. This addresses the desktop availability caused by cross cloud/cross regional issues.

Typically, a cloud desktop service provides a cloud desktop virtual machine to a group of users requiring a particular configuration in the form of a single pool of available desktops provisioned on one or more public “cloud provider regions.” The term “cloud provider region” is one of the regions where virtual machines can be provisioned from one of multiple public cloud providers.

Each user can have access to a cloud desktop virtual machine via a client device from the pool when needed. The resources such as processing, storage capability, applications and the like allocated to the desktop depends on the requirements of a user. However, in many instances, users may require less resources for the desktop. In other instances a user may require more resources for the desktop and thus the provided virtual desktop fails to meet user requirements.

There is a need for a cloud based system that automatically provides the optimal choice of cloud and region for providing a desktop pool to avoid unnecessary costs or lack of availability of virtual resources, based on changing conditions. Thus, there is also a need for a system that provides the capability to upgrade the resources for a virtual desktop based on utilization data. There is also a need for a system that provides the capability to downgrade the resources for a virtual desktop based on utilization data.

### SUMMARY

One disclosed example is a virtual desktop system including a cloud region that can provide a virtual desktop to a client device of a user. The virtual desktop has a specification of computing resources provided by the cloud region. The system includes a performance analysis service operable to collect operational data from use of the virtual desktop by the user. The performance analysis service analyzes use of the computing resources of the virtual desktop according to utilization ranges relative to the specification; and updates the specification for the virtual desktop based on a comparison of the utilization range and the specification. A control plane is coupled to the cloud region to adjust the computing resources of the cloud region for providing the virtual desktop based on the updated specification.

Another example is a method for managing computing resources for provision of a virtual desktop from a cloud region. A specification of computing resources is provided to provide the virtual desktop to a client device of a user. Operational data is collected from use of the virtual desktop by the user. Use of the computing resources of the virtual desktop is analyzed according to utilization ranges relative to the specification. The specification is updated for the virtual desktop based on a comparison of the utilization range and the specification. The computing resources of the cloud region are adjusted for providing the virtual desktop based on the updated specification.

Another example is a non-transitory computer-readable medium having machine-readable instructions stored thereon, which when executed by a processor, cause the processor to store a specification of computing resources to provide the virtual desktop to a client device of a user. The instructions cause the processor to collect operational data from use of the virtual desktop by the user. The instructions cause the processor to analyze use of the computing resources of the virtual desktop according to utilization ranges relative to the specification. The instructions cause the processor to update the specification for the virtual desktop based on a comparison of the utilization range and the specification. The instructions cause the processor to adjust the computing resources of the cloud region for providing the virtual desktop based on the updated specification.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The disclosure will be better understood from the following description of exemplary embodiments together with reference to the accompanying drawings, in which:

FIG. 1 is a high-level block diagram illustrating an example cloud desktop system allowing access to virtual desktops from different cloud providers;

FIG. 2 is a block diagram of a cloud region and desktop service control plane of the example cloud desktop fabric in FIG. 1;

FIG. 3 is a flow diagram of the general process of collecting operational data and changing resources for more efficient deployment of resources for provisioning and optimizing a desktop;

FIG. 4 is a flow diagram showing a continuous evaluation and desktop resource management routine;

FIG. 5 is an example working desktop specification;

FIG. 6 is an example table showing collected performance measurement data for an example desktop;

FIG. 7A shows a table of example configured under-utilization and over-utilization threshold values for different dimensions;

FIG. 7B shows a table of example aggregated metric data from a desktop for the dimensions in FIG. 7A;

FIG. 8 is an example scorecard of a desktop based on the aggregated metric data and utilization thresholds in FIGS. 7A-7B respectively;

FIG. 9 is an example revised requirement for a desktop based on analysis of the scorecard in FIG. 8; and

FIGS. 10 and 11 illustrate exemplary systems in accordance with various examples of the present disclosure.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION OF THE ILLUSTRATED EMBODIMENTS

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

The present disclosure relates to a virtual desktop system that collects operational data as to desktop requirements for users and with the collected data analyzes whether resources for the desktop meet such needs. In cases where the resources are underutilized or more resources are required for a desktop, the desktop resources are adjusted to provide the required resources or to reduce the use of under-utilized resources.

The following are definitions of terms used in this disclosure that relate in general to the virtual desktop pool management system.

An agent is software that performs certain operations and monitoring tasks that has direct access to, or runs on, some virtual computing resource and may maintain a duplex communication channel with a desktop service control plane.

An API is a set of specific, controlled, well-defined functional entry points to get, create, update, and delete resources and otherwise change the state of a remote system.

A cloud API is, in this context, an API specific to a cloud service provider.

A connection broker is desktop service resource sometimes used to dynamically connect desktop clients with desktops.

A cloud provider, also known as a cloud service provider, in this context, is an Infrastructure as a Service provider (IaaS) that provides virtual machines as a service in one or more cloud regions.

A cloud region is a collection of computing resources, such as virtual machine hosts, virtual networks, virtual storage devices, protocol gateways, servers, or other infrastructure in one physical location. The virtual resources are abstractions available to cloud customers, actually implemented by physical hardware such as networking equipment including but not limited to routers, hubs, switches, persistent storage devices such as disks, CPU and/or GPU processors, random access memory (RAM), security appliances including firewalls, operating system software, and other components that may be employed in a cloud regional data center to provide a hosting environment for virtual machines, sometimes known as a “server”, “host”, or “node.” A cloud region is typically described as being part of a public cloud, all the descriptions of the functionality apply equally to a private cloud whose availability is restricted to certain organizations.

A cloud availability zone is an isolated location within a cloud region, with some services that are redundant to other cloud availability zones within the same cloud region, in order to provide a higher level of availability in the event of an outage in a one location. A cloud service provider may allow resources such as virtual machines to be provisioned in a multiple specific availability zones, or may manage logical resources to be spread across availability zones automatically based on availability requirements, such as requiring that cloud resources are still available in the event of a power outage in one zone.

A virtual desktop is the information and capability needed to instantiate and manage, whenever needed, a specific virtual machine providing interactive desktop software or applications, or other experiences provided by remote desktop virtualization via a desktop service utilizing a cloud region.

A pool is a configuration object that describes a collection of virtual desktops, that is associated with a group of cloud desktop users, and certain attributes they have in common. For example, it may describe the common icon image used to launch a desktop.

A client, or desktop client (sometimes called a VDI client) is a software application that provides display and input access to a desktop as part of a desktop service. It may be installed on a standard desktop or mobile operating system, or be pre-installed on dedicated hardware devices, or downloaded dynamically via a web browser application, or deployed in some other way. Like an agent, it may also perform certain operations and monitoring tasks and may maintain a duplex communication channel with a desktop service control plane.

A cloud desktop fabric is a scalable virtual desktop interface system that orchestrates multiple regional fabric regions to allow a user anywhere to access a virtual desktop interface.

A desktop service resource refers to some virtualized hardware, networking service, or virtual machine, other than the desktops themselves, that exists to support a desktop service for use by cloud desktop users.

A desktop service is remote desktop virtualization hosted on a public or private cloud, provided as a turnkey managed service.

A desktop service control plane is an application that implements and manages a desktop service.

A cloud desktop user, also referred to as user, is a person who uses a cloud desktop.

An enterprise connector is a desktop service resource used to integrate the network of a desktop service with the network services, including but not limited to directory services that support authentication and authorization.

A gateway, sometimes referred to as a protocol gateway, is a type of desktop service resource running a service that manages secure access to a desktop supporting protocols including a remote display protocol (RDP). In this disclosure, gateways are accessed as a gateway cluster unless explicitly noted otherwise.

A gateway cluster is a set of gateways managed together for load balancing purposes.

Infrastructure as a service (IaaS) is a set of virtualized computing resources available from a cloud service provider.

An infrastructure template is a collection of desktop service resources and/or definitions that provide a blueprint for replicating a cloud region's resources.

A multi-tenant desktop service control plane is a single desktop service control plane implementation that is used by multiple customers in such a way that no single customer is aware of or is impacted by activities of the others.

The term “near-real-time” refers to the processing timeframe of a system in which root cause information is produced without significant delay, close enough in time from the triggering events to be acted upon immediately to achieve business goals, typically measured as under one minute.

A non-persistent desktop user is a desktop user that is allocated a new desktop for each login session.

A persistent desktop user is a desktop user that is allocated a specific desktop for exclusive use over multiple connection sessions.

Pool desktops are a set of desktops managed by the desktop service control plane as a unit.

Remote desktop virtualization is software technology that separates the desktop environment and associated application software from the physical client device that is used to access it in a client/server environment.

A virtual application is the capability to access a user experience for a particular application running remotely.

A virtualized computing resource is a virtual machine that is created by an Infrastructure as a Service (IaaS) provider.

A virtual machine is an emulation of a physical computer that can be accessed over a network.

A virtual network is hardware and software network resources combined into a single, software-based administrative entity, made available by an Infrastructure as a Service (IaaS) provider.

Virtual storage is storage resources provided as part of Infrastructure as a Service.

The present disclosure relates to systems and methods to provide efficient desktop services to users. A global, multi-cloud virtual desktop system allows a user to connect to a virtual desktop from any networked location in the world, by pairing each network location with a cloud region that hosts the required infrastructure (such as a protocol gateway) as well as a desktop virtual machine.

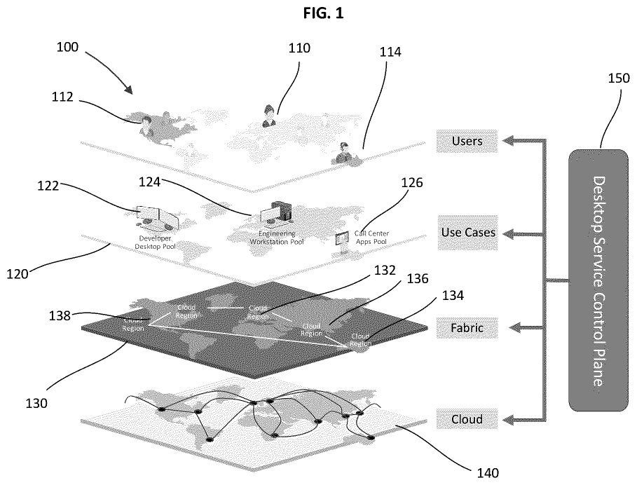

FIG. 1 shows a high level block diagram of a cloud desktop service system 100. The cloud desktop service system 100 may also be referenced as a global desktop system because it provides virtual desktops for users globally. The cloud desktop service system 100 includes four layers, a users layer 110, a use cases layer 120, a fabric layer 130, and a cloud layer 140.

The users layer 110 represents desktop users having the same computing needs, that may be located anywhere in the world. In this example, the users layer 110 includes users 112 and 114, who are in geographically remote locations and access desktops via computing devices.

The use cases layer 120 represents common global pools of desktops available to serve the users, whereby each global pool is based on a common desktop template. There can be multiple global pools based on which groups users belong to and their job requirements. In this example, the pool for the users 112 and 114 may be one of a developer desktop pool 122, an engineering workstation pool 124, or a call center application pool 126. The desktops each include configuration and definitions of resources necessary to offer the desktop. The use cases layer 120 represents common pools of desktops available to serve the users, whereby each logical pool may be based on common desktop requirements. There can be multiple pools based on which groups users belong to and their job requirements. In this example, the pool for the users 112 and 114 may be one of a developer desktop pool 122, an engineering workstation pool 124, or a call center application pool 126. The desktops each include configuration and definitions of resources necessary to offer the desktop. The desktops in a particular pool may each be supported by different cloud regions based on the requirement of the desktop pool.

For example, pools such as the developer desktop pool 122 or the engineering workstation pool 124 allow users in the pool a desktop that allows access to graphic processing unit (GPU) based applications. Other example applications may include those applications used for the business of the enterprise, for example, ERP (enterprise resource planning) applications or CRM (customer relationship management) applications. These applications allow users to control the inventory of the business, sales, workflow, shipping, payment, product planning, cost analysis, interactions with customers, and so on. Applications associated with an enterprise may include productivity applications, for example, word processing applications, search applications, document viewers, and collaboration applications. Applications associated with an enterprise may also include applications that allow communication between people, for example, email, messaging, web meetings, and so on.

The fabric layer 130 includes definitions and configurations for infrastructure and desktop service resources, including gateways, desktop templates, and others that are applied to cloud regions. The resources are maintained as cloud regions such as cloud regions 132, 134, 136, and 138. The cloud regions can be added or removed as needed.

The cloud layer 140 implements the resources defined by the use case layer 120 and fabric layer 130, including virtual desktops, infrastructure, and other virtual resources, all of which are virtual machines or other virtual resources hosted in a public cloud.

The layers 110, 120, 130, and 140 are created and orchestrated by a desktop service control plane 150 that can touch all the layers. The desktop service control plane 150 is a key component to orchestrate a cloud desktop service system such as the cloud desktop service system 100 in FIG. 3. The desktop service control plane 150 can manage the entire lifecycle of a desktop service implementation, from creating and managing the required desktops, to monitoring and analyzing the stream of operational data collected, enforcing security policies, and optimizing the experience for IT administrators and desktop users. For example, the desktop service control plane 150 may register a set of a virtual networks, virtual storage resources, and more. Within a virtual network, the control plane 150 may further register and coordinate the use of gateways, enterprise connectors, desktop templates, connection brokers, and more.

The two desktop users 112 and 114 in different parts of the world who are each able to access an example high-performance desktop service from the cloud desktop service system 100. As will be explained below, the cloud desktop service system 100 eliminates the need to divide users with similar requirements into user groups specific to a region. Rather, all users having similar needs throughout the world are considered as a single worker pool. Users, such as users 112 and 114, each may use a client device to access the desktop service. Client devices may be any device having computing and network functionality, such as a laptop computer, desktop computer, smartphone, or tablet. Client devices execute a desktop client to access remote applications such as the desktop. The client application authenticates user access to the applications. A client device can be a conventional computer system executing, for example, a Microsoft™ Windows™-compatible operating system (OS), Apple™ OS X, and/or a Linux distribution. A client device can also be a client device having computer functionality, such as a personal digital assistant (PDA), mobile telephone, tablet, video game system, etc. In this example, the client application displays an icon of the desktop or desktops available to the user. As will be explained, the desktop is made available to the user through the client application on the user device.

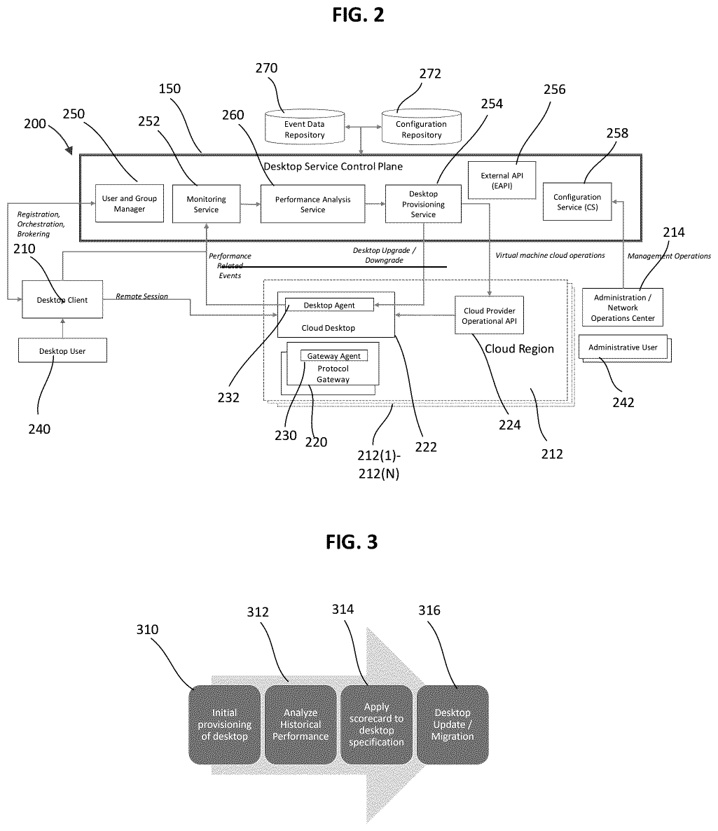

FIG. 2 is a block diagram of some examples of components of the cloud desktop service system 100, including an example set of desktop clients 210, a cloud region 212, and an administration center 214, that interact with and can be orchestrated by the desktop service control plane 150. The desktop client 210 communicates with the desktop service control plane 150 in order to be registered with the fabric, assigned a desktop, remotely configured, and for other purposes. There may be multiple cloud regions (e.g., cloud regions 212(1) to 212(N)) similar to the cloud region 212, but only one cloud region 212 is shown in detail for simplicity of explanation. The cloud region 212 may include a set of protocol gateways 220, a set of managed virtual desktops 222, and a cloud service provider operational API 224. These components all communicate with the desktop service control plane 150. The cloud region 212 may be one of the cloud regions 132, 134, 136, and 138 in FIG. 1.

Such cloud regions include servers that host the various applications as well as appropriate storage capabilities, such as virtual disks, memory, and network devices. Thus, the cloud region 212 typically comprises IT infrastructure that is managed by IT personnel. The IT infrastructure may include servers, network infrastructure, memory devices, software including operating systems, and so on. If there is an issue related to an application reported by a user, the IT personnel can check the health of the infrastructure used by the application. A cloud region may include a firewall to control access to the applications hosted by the cloud region. The firewall enables computing devices behind the firewall to access the applications hosted by the cloud region, but prevents computing devices outside the firewall from directly accessing the applications. The firewall may allow devices outside the firewall to access the applications within the firewall using a virtual private network (VPN).

The protocol gateway 220 may be present to provide secure public or internal limited access to the managed virtual desktops, that may be deployed on a virtual machine of its own. A gateway agent 230 is software that is deployed on that gateway virtual machine by the desktop service control plane 150, serves to monitor the activity on the gateway 220, and enable the desktop service control plane 150 to assist in configuration and operations management of the gateway 220.

The example desktop client 210 is software and device hardware available in the local environment of a desktop user 240 to remotely access a managed virtual desktop using a remote desktop protocol. Thus, the desktop client 210 may be a user device operated by the desktop user 240. The desktop client 210 communicates with the desktop service control plane 150 and also supports a remote display protocol in order for users to connect to a desktop application run by the cloud region 212.

The managed virtual desktop 222 is itself provisioned and maintained by the desktop service control plane 150. A desktop template may be used to manage pools of such managed virtual desktops. The desktop template is configured to provide remote access to the desktop client 210. A desktop agent such as desktop agent 232 is software that is deployed on that managed virtual desktop by the desktop service control plane 150. The desktop agent 232 serves to monitor the activity on the managed virtual desktop, and enable the desktop service control plane 150 to assist in configuration and operations management of the managed virtual desktop.

The cloud service provider operational application programming interface (API) 224 presents services provided by the cloud service provider that also participate in the management of the virtual machine. This can be utilized by a desktop service control plane 150 to perform operations like provisioning or de-provisioning the virtual machine for supporting a desktop such as the desktop 222 for the client devices such as the desktop client 210.

Administrative users 242 can interact with operations reporting interface software at the administration center 214 that allows management and administration of the desktop service control plane 150.

Other components and services may interact with the desktop service control plane but are omitted from FIG. 2 for simplicity, such as enterprise connectors, network monitoring services, customer relationship management (CRM) systems, and many others.

The desktop service control plane 150 itself can perform many internal centralized functions also not depicted in in FIG. 2, including pool management, user and group management, cloud service adaption, managing virtual desktop templates, data analysis, high-availability management, mapping users to the optimal cloud region, security policy management, monitoring, compliance, reporting, and others.

The control plane 150 includes a user and group manager 250, a monitoring service 252, a desktop provisioning service 254, an external API (EAPI) 256, and a configuration service (CS) 258. The control plane 150 also includes a performance analysis service 260, which evaluates the performance of the desktops 222 in all of the regional cloud regions such as the cloud region 212. The control plane 150 may access an event data repository 270 and a configuration repository 272. Although only one cloud region 212 is shown in detail, it is to be understood that the control plane 150 may facilitate numerous cloud regions such as the cloud regions 212(1) to 212(N).

The monitoring service 252 makes both routine and error events available to administrators and can analyze operational performance and reliability. The monitoring service 252 interacts with components including the desktop client 210, desktop agent 232, gateway agent 230, and those generated by the control plane 150 itself. The desktop provisioning service 254 interacts with the one or more managed virtual machines (MVMs) that execute the desktops 222 in the cloud region 212 and other regional cloud regions 212(1) to 212(N). In this example, the desktop provisioning service 254 manages resources for providing instantiated desktops to the users in the pools, orchestrating the lifecycle of a virtual desktop.

In this example, the desktop service control plane 150 is responsible for orchestrating provisioning, monitoring, and management of a cloud desktop such as the desktop 222 for end users such as the user 240. The example desktop client 210 provides access on an endpoint device and communicates with the desktop service control plane 150 as well as creating remote display protocol connections with the cloud desktop 222 itself (usually through a protocol gateway, such as the protocol gateway 220). The desktop client 210 also provides performance-related event data to the monitoring service 252, such as connection times, network quality, and so on.

The example cloud desktop client 210 hosts the desktop agent 232 that is a software program that assists in desktop operations and gathers performance-related event data for the monitoring service 252. The example monitoring service 252 is one way to gather raw performance measurement data for purposes of providing the most efficient resources for the desktop from the cloud region 212. Such performance measurement data is stores in the event data repository 270.

As will be explained, the performance analysis service 260 aggregates of historical event data in relation to the operation of the desktops such as the desktop 222. The performance analysis service 260 produces dimensional metrics, desktop scorecards, and plans to update desktops in-place or to migrate them to most efficiently use the resources of the cloud regions such as the cloud regions 212 and 212(1) to 212(N).

The desktop provisioning service 254 is an example of a service that reacts to plans for changing the desktop requirements produced by the performance analysis service 260 by implementing desktop updates, finding suitable desktop replacements, and orchestrating desktop migration, including providing launch information to the desktop client 210, desktop agent 232, and/or the cloud provider APIs if needed to make the migration to another virtual machine transparent to the end-user.

The administration center 214 works directly with the desktop service control plane 150 as its primary human interface. The administration center 214 allows the administrative user 242 to configure the functions of the control plane 150 through the configuration service 258. The configuration service 258 supports editing and persistence of definitions about the desktop service, including subscription information and policies. The administration center 214 may be where the desktop requirement dimensions are configured by the administrative user 242. The system 200 in FIG. 2 allows the creation and management of virtual desktops based on dynamic resource requirements for a user as will be explained below. The configuration service 258 in this example allows administrative users such as the administrative user 242 to configure specifications, rules, profiles, or other policies to control the automatic right-sizing process.

The performance analysis service 260 allows adjustment of computing resources to ensure performance of a virtual desktop meets the expected user experience while maximizing efficient use of resources. Typically, the experience varies with the class of desktop components provided to the user because of the different levels of resources required. The performance analysis service 260 continuously gathers performance results that it may transform into findings that trigger and update the desktop of a user. The control plane 150 may also orchestrate a transparent migration of a user to a new desktop. Dimensions that affect the “right-sized” specification of computing resources for the desktop can include, but are not limited to, such dimensions as: CPU (as expressed by number of CPU cores); RAM memory (GB); disk size (GB); disk class (Solid State Drive (SSD) or standard); and presence of Graphical Processing Unit (GPU).

FIG. 3 shows an example process of adjustment of resource utilization in providing desktops that is performed by the performance analysis service 260 in FIG. 2. The process initially provisions a desktop for the user (310), based on a working specification derived from user requirements. The process then analyzes recent actual performance data of the desktop, such as CPU, Memory, and Disk sample utilization readings, to create a “scorecard” of over-utilization or under-utilization (312). The process then applies the scorecard (314). For example, if the scorecard indicates over-utilization or under-utilization, the desktop specification is changed to reflect the modified requirements for the user (316).

Guided by configurations, policies, or other constraints, the routine in FIG. 3 may make appropriate changes to the desktop to improve user experience (by increasing the performance of the desktop) or better manage costs (by decreasing the performance of the desktop) when more resources than necessary are allocated to provide the user experience. These actions can take different forms.

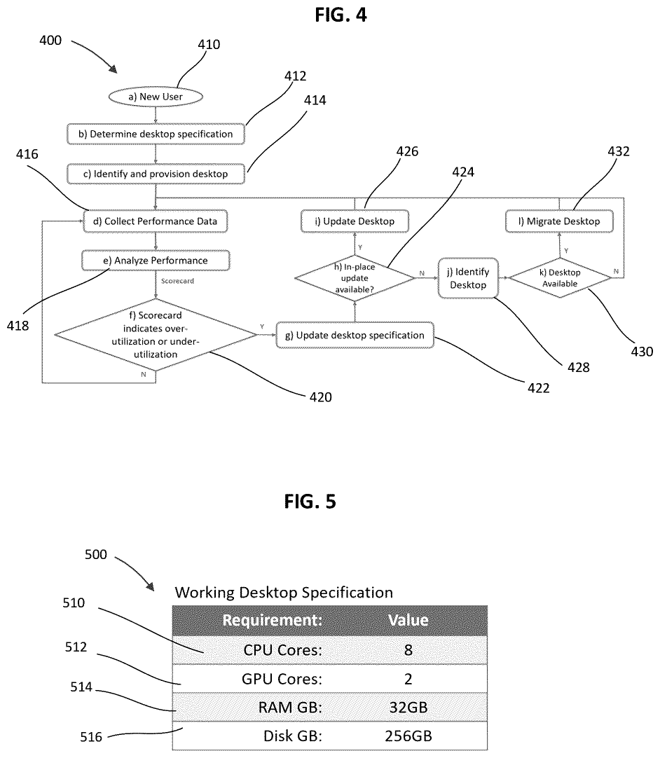

This is deployed as a continuous loop of evaluation of resource utilization in providing the desktop and possible resource allocation action. One embodiment of the specific steps of a continuous evaluation and resource allocation routine is illustrated in a flow chart 400 in FIG. 4. The routine in FIG. 4 is run by the various services, such as the performance analysis service 260, in the control plane 150 in FIG. 2.

FIG. 4 is a flow diagram of the routine to collect constraint and usage data for reallocating computing resources in providing desktops. In this example, the machine readable instructions comprise an algorithm for execution by: (a) a processor, (b) a controller, and/or (c) one or more other suitable processing device(s). The algorithm may be embodied in software stored on tangible media such as flash memory, CD-ROM, floppy disk, hard drive, digital video (versatile) disk (DVD), or other memory devices. However, persons of ordinary skill in the art will readily appreciate that the entire algorithm and/or parts thereof can alternatively be executed by a device other than a processor and/or embodied in firmware or dedicated hardware in a well-known manner (e.g., it may be implemented by an application specific integrated circuit [ASIC], a programmable logic device [PLD], a field programmable logic device [FPLD], a field programmable gate array [FPGA], discrete logic, etc.). For example, any or all of the components of the interfaces can be implemented by software, hardware, and/or firmware. Also, some or all of the machine readable instructions represented by the flowcharts may be implemented manually. Further, although the example algorithm is described with reference to the flowcharts illustrated in FIG. 4, persons of ordinary skill in the art will readily appreciate that many other methods of implementing the example machine readable instructions may alternatively be used. For example, the order of execution of the blocks may be changed, and/or some of the blocks described may be changed, eliminated, or combined.

First, a new user requiring a desktop is established in the system (410). A desktop specification for the user desktop is determined based on the needs of the new user (412). The desktop specification is the computing resources such as number of CPU cores; RAM memory, disk size, disk class, and GPU cores.

As explained above, the desktop specification may depend on the role of the user. A desktop for the user based on the working desktop specification is identified and provisioned by one of the Cloud regions via the control plane 150 (414).

FIG. 5 shows an example of a working desktop specification 500 including parameters for dimensions such as CPU cores 510, GPU cores 512, RAM size 514 and storage size 516. Thus, a class of available desktop is identified that meets the example requirements above. In this example, the values for the respective desktop requirements in dimensions 510, 512, 514 and 516 are having 8 CPU cores, 2 GPU cores, 32 GB RAM, and a 256 GB disk. One way to implement assignment of a desktop to a user is to identify a desktop pool consisting of available desktops by comparing the attributes of the desktop pool to the specification, and to assign the user to that desktop pool if the requirements are met. When the user launches the assigned desktop, the desktop from the desktop pool thus meets the initial requirements of the desktop. The user begins using the desktop from the client device.

Returning to FIG. 4, during use of the desktop, data is collected for the user, in the form of a time series of data points that describe performance (that affects user experience) in various dimensions (416). For example, CPU utilization, RAM utilization, and disk utilization may all be timestamped and captured by observability mechanisms, including but not limited to a desktop agent such as the desktop agent 232 in FIG. 2 forwarding information from the cloud desktop operating system or remote desktop protocol service, or user feedback scores to the performance analysis service 260.

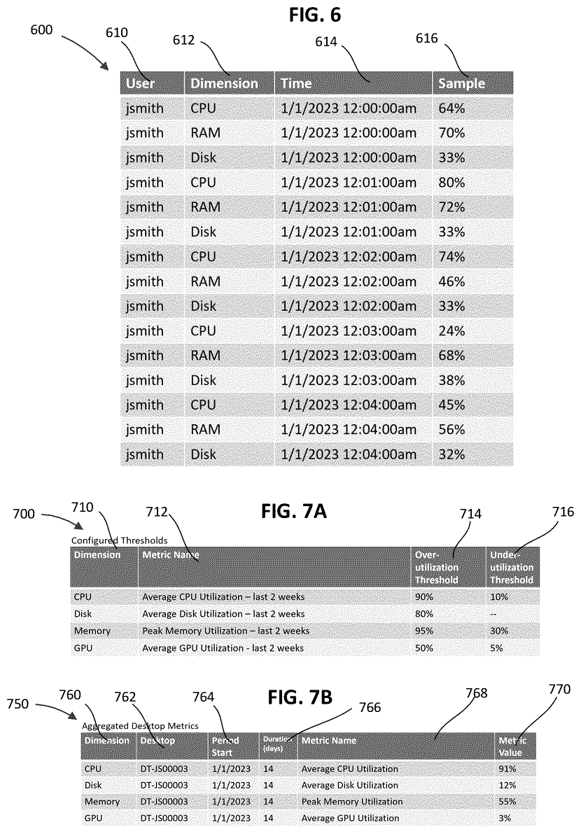

An illustration of performance measurements collected for three dimensions every minute may be shown in the table 600 in FIG. 6. The table 600 compiles data collected periodically in a user column 610, a dimension column 612, a time column 614 and a sample utilization value column 616. The rows of the table 600 show time stamped samples of CPU utilization, RAM utilization, and disk utilization every minute (entered in the time column 614) in the sample utilization value column 616 collected from use of a desktop provided by the system 200 in FIG. 2. The data is collected for the different dimensions based on the entry in the dimension column 612.

Returning to FIG. 4, periodically, the desktop service control plane 150 performs aggregation and analysis of performance data (418). For example, the sample CPU readings for a particular period (such as the last 14 days) could be aggregated together by a mathematical average to produce an overall metric. As explained below, each metric may be compared to a configured threshold. Metrics that exceed the configured threshold may indicate whether there is over-utilization or under-utilization for that metric. These findings themselves may be aggregated into an overall finding for a dimension such as ‘CPU’, using some configured or encoded rule (420). For example, there could be a rule that if any metric related to the ‘CPU’ dimension indicates over-provisioning, then the CPU dimension itself is over-provisioned. Alternatively the metrics could have weights associated with them to determine how they are combined. Thus, the analysis may or may not produce findings that relate to over-utilization or under-utilization in the context of any or all categories used for the specification of the desktop according to configured or encoded rules (420).

Other information may be obtained from the desktop service control plane 150 to augment the interpretation of the data. This information may include, for example, the work schedule or application load of a particular user. For example, there may be seasonal needs such as end-of-month financial jobs that may require a higher level of CPU power. This information could be integrated into the desktop service control plane 150 from external systems (such as enterprise resource planning or financial systems), or configured by administrative users 242, or some combination of these techniques. Another example of administrative constraints set by administrative users 242 could include cost constraints. This can help handle predictable fluctuating requirements.

FIG. 7A shows a table 700 of a simplified example thresholds used by configured or encoded rules to determine if each dimension indicates over-utilization or under-utilization. For simplicity of illustration, each dimension is represented by a single metric in this example. Thus, the table 700 has rows representing an individual dimension (CPU, disk, memory, and GPU) as listed in a dimension column 710. For each column, values are provided in a metric name column 712, an over-utilization threshold column 714, and an under-utilization threshold column 716. The metric names in the metric column 712 provide descriptions of the metrics of the specific dimension. The threshold values in the threshold columns 714 and 716 are percentage of utilization over a period of time such as two weeks. The table 700 shows over-utilization and under-utilization thresholds for CPUs utilization, disk utilization, memory utilization and GPU utilization for a two week period. For example, a CPU may be deemed over-utilized if the average utilization over 2 weeks is over 90% while a CPU may be deemed under-utilization if the average utilization over 2 weeks is under 10%. These rules could be fine-tuned by system administrators. There may be cases where there is no threshold. For example, the table 700 does not have an under-utilization threshold for the disk of the desktop.

FIG. 7B shows a table 750 of aggregated metrics from an example desktop over a two week period for each of the dimensions in the table 700 as listed in a dimensions column 760. Each dimension row has a corresponding desktop identification in a desktop column 762, a period start in a period start column 764, a duration in a duration column 766, a metric name in a metric name column 768, and a metric value in a metric value column 770. Thus, the table 750 shows an average CPU utilization of 91%, an average disk utilization of 12%, an average memory utilization of 55%, and an average GPU utilization of 3% for the example desktop DT-JS00003 for the two week duration.

The analysis performed by the performance analysis service 260 can combine the aggregated metrics for the desktop with the configured or encoded rules to produce a performance scorecard for the last period, as illustrated below. In this embodiment, there may be 3 distinct utilization values associated with each dimension. These values are over (where user experience may be impacted); in range; and under (where costs may be impacted unnecessarily).

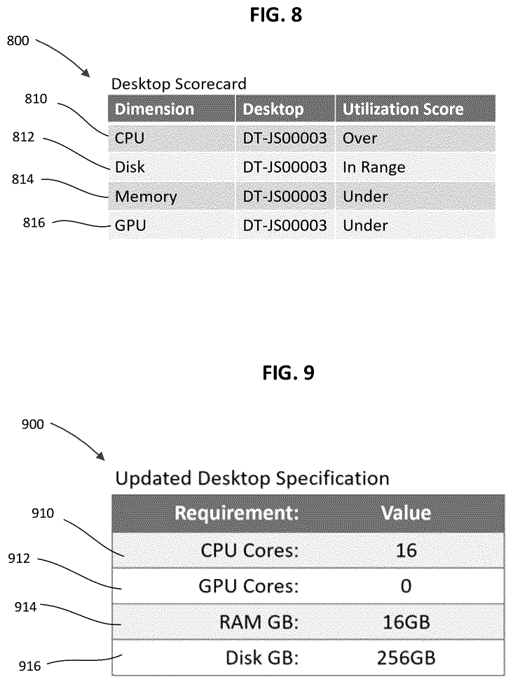

FIG. 8 shows an example scorecard 800 that summarizes whether the utilization score of different dimensions of the desktop with utilization data in FIG. 7B are either over or under different utilization ranges. Thus, as shown in the scorecard 800, the CPU is considered over-utilized (810) and thus a higher performing class of CPU may be required. Disk utilization is within the normal range (812) and no action is needed. Memory and the GPU are under-utilized (814) and (816). The GPU is not really used and can be eliminated from the desktop requirements of the user in this example. In some implementations, the application load as reported by the desktop service control plane 150 may also be used to affect that logic. For example, a GPU may still be required in order to run certain applications even if under-utilization is detected.

Returning to FIG. 4, in the evaluation (420), if the scorecard findings indicate the desktop is not over-utilized or under-utilized in any dimension, the routine resumes monitoring the desktop performance (416). If any of the dimensions are either over-utilized or under-utilized (420) such as the over-utilization of the CPU or under-utilization of the memory in the scorecard 800 in FIG. 8, the routine updates the desktop specification (422).

The update of the desktop specification involves analyzing the scorecard findings according to configured or encoded rules. Continuing the example of the original specification 500 in FIG. 5 with the analysis based on the scorecard 800 in FIG. 8, an updated desktop specification 900 may be prepared as shown in FIG. 9. The updated specification 900 includes parameters for CPU cores 910, GPU cores 912, RAM size 914 and storage size 916 similar to the original specification 500 in FIG. 5. The updated desktop specification 900 shows that the CPU parameter 910 has been augmented (16 cores over 8 cores) while the RAM memory parameter 914 has been reduced (16 GB from 32 GB), while the disk size parameter 916 is not changed. The user has not used the GPU recently, and can now be allocated a machine without GPUs based on the new GPU parameter 912 (from original allocation of 2 GPUs in FIG. 5), representing a significant cost saving.

There may be multiple strategies and constraints to handle changing desktop requirements. This step is part of evaluating one approach that may be preferred, and is also controlled by configured or encoded rules. This means instead of provisioning a whole new desktop, the desktop can be modified in place using cloud provider services. This is preferred if it is possible and if the user's desktop has persistent state and disk between login sessions

Thus, the routine in FIG. 4 determines whether an in-place replacement change for the desktop is available (424). If a replacement for the dimension or dimensions is available, the routine updates the desktop (426). For example, the new desktop specification may simply call for a larger disk, and this may be accomplished by the control plane 150 sending a command to the cloud service that manages the desktop to increase the disk size of the virtual desktop. Once done, the system returns to resume monitoring of performance (414).

If an in-place replacement is not available (424), the routine will identify the desktop specification (428). The routine already knows that there will be an attempt to replace the user's desktop with a different one that fits the needs of the user better. In some implementations the replacement may involve an automated search of cloud resource offerings to see if a better desktop exists that may be instantiated or re-used that matches the updated desktop specification more closely (430). This replacement may involve migrating the desktop into a different cloud region. Once again this implementation may involve configured or encoded rules to make this selection. For example, this logic may check against a service offering catalog of the cloud provider of the cloud region or regions, and may consider a configured minimum or maximum specification or may use other rules to manage the cost and/or user experience. Constraints to ensure performance or other goals may also be checked to manage the modification of the desktop. For example, applications may experience errors if disk capacity is reduced, and thus this type of downgrade may not be allowed. It is also possible that the candidate right-sized desktop may be available in a different cloud region from the current desktop. The “best fit” desktop is identified and the desktop may be provided by the different cloud region.

The routine identifies an alternative desktop pool with different performance specification. In this example, this may be a desktop pool consisting of desktops that are 16 core/32 GB RAM/256 GB disk. There may be no identified desktop, or the identified desktop may or may not actually be available at this time (430). It may be possible to expand the size of the pool by provisioning additional desktops and create availability in that matter. If an upgraded or downgraded desktop is not available, the routine loops back to monitoring performance (416). If a desktop is available (430), the desktop is migrated to the cloud resource such as the same or different data center with a desktop that conforms to the updated specification (432).

In some implementations, if the user has a persistent state associated with the desktop, this may be accomplished without disruption to the user by migrating the existing desktop's current disk image to a desktop in a different desktop pool, and automatically reassigning the user to the new desktop pool in a fashion that is as transparent as possible to the end user. For example, the same launch icon may be presented, and the only detectable difference is the improved performance. In some scenarios, a logout/login or power cycle may be required. Once migrated, monitoring of performance data continues (416).

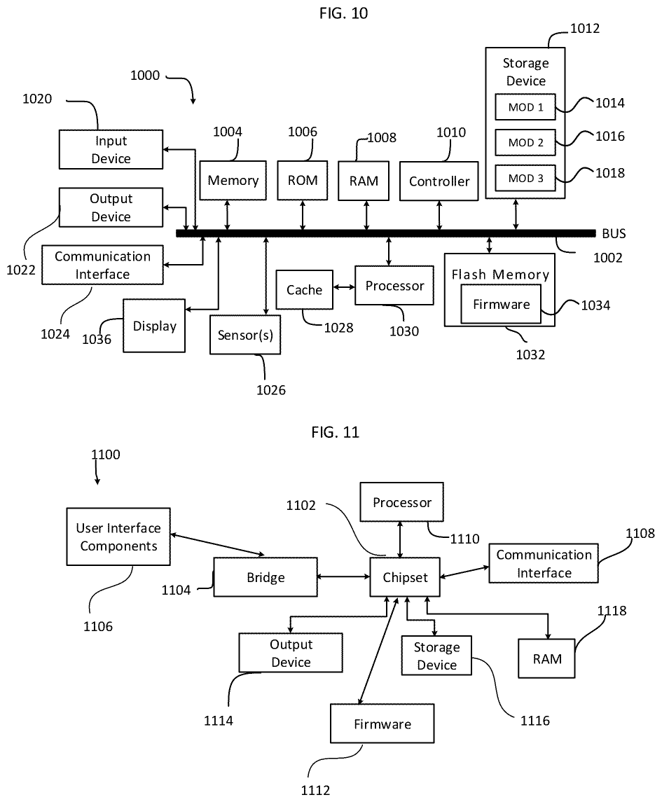

FIGS. 10-11 illustrate an example computing system 1000, in which the components of the computing system are in electrical communication with each other using a bus 1002. The system 1000 includes a processing unit (CPU or processor) 1030 and a system bus 1002 that couple various system components, including the system memory 1004 (e.g., read only memory (ROM) 1006 and random access memory (RAM) 1008), to the processor 1030. The system 1000 can include a cache of high-speed memory connected directly with, in close proximity to, or integrated as part of the processor 1030. The system 1000 can copy data from the memory 1004 and/or the storage device 1012 to the cache 1028 for quick access by the processor 1030. In this way, the cache can provide a performance boost for processor 1030 while waiting for data. These and other modules can control or be configured to control the processor 1030 to perform various actions. Other system memory 1004 may be available for use as well. The memory 1004 can include multiple different types of memory with different performance characteristics. The processor 1030 can include any general purpose processor and a hardware module or software module, such as module 1 1014, module 2 1016, and module 3 1018 embedded in storage device 1012. The hardware module or software module is configured to control the processor 1030, as well as a special-purpose processor where software instructions are incorporated into the actual processor design. The processor 1030 may essentially be a completely self-contained computing system that contains multiple cores or processors, a bus, memory controller, cache, etc. A multi-core processor may be symmetric or asymmetric.

To enable user interaction with the computing device 1000, an input device 1020 is provided as an input mechanism. The input device 1020 can comprise a microphone for speech, a touch-sensitive screen for gesture or graphical input, keyboard, mouse, motion input, and so forth. In some instances, multimodal systems can enable a user to provide multiple types of input to communicate with the system 1000. In this example, an output device 1022 is also provided. The communications interface 1324 can govern and manage the user input and system output.

Storage device 1012 can be a non-volatile memory to store data that is accessible by a computer. The storage device 1012 can be magnetic cassettes, flash memory cards, solid state memory devices, digital versatile disks, cartridges, random access memories (RAMs) 1008, read only memory (ROM) 1006, and hybrids thereof.

The controller 1010 can be a specialized microcontroller or processor on the system 1000, such as a BMC (baseboard management controller). In some cases, the controller 1010 can be part of an Intelligent Platform Management Interface (IPMI). Moreover, in some cases, the controller 1010 can be embedded on a motherboard or main circuit board of the system 1000. The controller 1010 can manage the interface between system management software and platform hardware. The controller 1010 can also communicate with various system devices and components (internal and/or external), such as controllers or peripheral components, as further described below.

The controller 1010 can generate specific responses to notifications, alerts, and/or events, and communicate with remote devices or components (e.g., electronic mail message, network message, etc.) to generate an instruction or command for automatic hardware recovery procedures, etc. An administrator can also remotely communicate with the controller 1010 to initiate or conduct specific hardware recovery procedures or operations, as further described below.

The controller 1010 can also include a system event log controller and/or storage for managing and maintaining events, alerts, and notifications received by the controller 1010. For example, the controller 1010 or a system event log controller can receive alerts or notifications from one or more devices and components, and maintain the alerts or notifications in a system event log storage component.

Flash memory 1032 can be an electronic non-volatile computer storage medium or chip that can be used by the system 1000 for storage and/or data transfer. The flash memory 1032 can be electrically erased and/or reprogrammed. Flash memory 1032 can include EPROM (erasable programmable read-only memory), EEPROM (electrically erasable programmable read-only memory), ROM, NVRAM, or CMOS (complementary metal-oxide semiconductor), for example. The flash memory 1032 can store the firmware 1034 executed by the system 1000 when the system 1000 is first powered on, along with a set of configurations specified for the firmware 1034. The flash memory 1032 can also store configurations used by the firmware 1034.

The firmware 1034 can include a Basic Input/Output System or equivalents, such as an EFI (Extensible Firmware Interface) or UEFI (Unified Extensible Firmware Interface). The firmware 1034 can be loaded and executed as a sequence program each time the system 1000 is started. The firmware 1034 can recognize, initialize, and test hardware present in the system 1000 based on the set of configurations. The firmware 1034 can perform a self-test, such as a POST (Power-On-Self-Test), on the system 1000. This self-test can test the functionality of various hardware components such as hard disk drives, optical reading devices, cooling devices, memory modules, expansion cards, and the like. The firmware 1034 can address and allocate an area in the memory 1004, ROM 1006, RAM 1008, and/or storage device 1012, to store an operating system (OS). The firmware 1034 can load a boot loader and/or OS, and give control of the system 1000 to the OS.

The firmware 1034 of the system 1000 can include a firmware configuration that defines how the firmware 1034 controls various hardware components in the system 1000. The firmware configuration can determine the order in which the various hardware components in the system 1000 are started. The firmware 1034 can provide an interface, such as an UEFI, that allows a variety of different parameters to be set, which can be different from parameters in a firmware default configuration. For example, a user (e.g., an administrator) can use the firmware 1034 to specify clock and bus speeds, define what peripherals are attached to the system 1000, set monitoring of health (e.g., fan speeds and CPU temperature limits), and/or provide a variety of other parameters that affect overall performance and power usage of the system 1000. While firmware 1034 is illustrated as being stored in the flash memory 1032, one of ordinary skill in the art will readily recognize that the firmware 1034 can be stored in other memory components, such as memory 1004 or ROM 1006.

System 1000 can include one or more sensors 1026. The one or more sensors 1026 can include, for example, one or more temperature sensors, thermal sensors, oxygen sensors, chemical sensors, noise sensors, heat sensors, current sensors, voltage detectors, air flow sensors, flow sensors, infrared thermometers, heat flux sensors, thermometers, pyrometers, etc. The one or more sensors 1026 can communicate with the processor, cache 1028, flash memory 1032, communications interface 1024, memory 1004, ROM 1006, RAM 1008, controller 1010, and storage device 1012, via the bus 1002, for example. The one or more sensors 1026 can also communicate with other components in the system via one or more different means, such as inter-integrated circuit (I2C), general purpose output (GPO), and the like. Different types of sensors (e.g., sensors 1026) on the system 1000 can also report to the controller 1010 on parameters, such as cooling fan speeds, power status, operating system (OS) status, hardware status, and so forth. A display 1036 may be used by the system 1000 to provide graphics related to the applications that are executed by the controller 1010.

FIG. 11 illustrates an example computer system 1100 having a chipset architecture that can be used in executing the described method(s) or operations, and generating and displaying a graphical user interface (GUI). Computer system 1100 can include computer hardware, software, and firmware that can be used to implement the disclosed technology. System 1100 can include a processor 1110, representative of a variety of physically and/or logically distinct resources capable of executing software, firmware, and hardware configured to perform identified computations. Processor 1110 can communicate with a chipset 1102 that can control input to and output from processor 1110. In this example, chipset 1102 outputs information to output device 1114, such as a display, and can read and write information to storage device 1116. The storage device 1116 can include magnetic media, and solid state media, for example. Chipset 1102 can also read data from and write data to RAM 1118. A bridge 1104 for interfacing with a variety of user interface components 1106, can be provided for interfacing with chipset 1102. User interface components 1106 can include a keyboard, a microphone, touch detection, and processing circuitry, and a pointing device, such as a mouse.

Chipset 1102 can also interface with one or more communication interfaces 1108 that can have different physical interfaces. Such communication interfaces can include interfaces for wired and wireless local area networks, for broadband wireless networks, and for personal area networks. Further, the machine can receive inputs from a user via user interface components 1106, and execute appropriate functions, such as browsing functions by interpreting these inputs using processor 1110.

Moreover, chipset 1102 can also communicate with firmware 1112, which can be executed by the computer system 1100 when powering on. The firmware 1112 can recognize, initialize, and test hardware present in the computer system 1100 based on a set of firmware configurations. The firmware 1112 can perform a self-test, such as a POST, on the system 1100. The self-test can test the functionality of the various hardware components 1102-1118. The firmware 1112 can address and allocate an area in the memory 1118 to store an OS. The firmware 1112 can load a boot loader and/or OS, and give control of the system 1100 to the OS. In some cases, the firmware 1112 can communicate with the hardware components 1102-1110 and 1114-1118. Here, the firmware 1112 can communicate with the hardware components 1102-1110 and 1114-1118 through the chipset 1102, and/or through one or more other components. In some cases, the firmware 1112 can communicate directly with the hardware components 1102-1110 and 1114-1118.

It can be appreciated that example systems 1000 (in FIGS. 10) and 1100 can have more than one processor (e.g., 1030, 1110), or be part of a group or cluster of computing devices networked together to provide greater processing capability.

As used in this application, the terms “component,” “module,” “system,” or the like, generally refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller, as well as the controller, can be a component. One or more components may reside within a process and/or thread of execution, and a component may be localized on one computer and/or distributed between two or more computers. Further, a “device” can come in the form of specially designed hardware, generalized hardware made specialized by the execution of software thereon that enables the hardware to perform specific function, software stored on a computer-readable medium, or a combination thereof.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

What is claimed is:

1. A virtual desktop system comprising:
a cloud region that can provide a virtual desktop to a client device of a user, wherein the virtual desktop has a specification of computing resources provided by the cloud region;
a performance analysis service operable to:
collect operational data from use of the virtual desktop by the user:
analyze use of the computing resources of the virtual desktop according to utilization ranges relative to the specification; and
update the specification for the virtual desktop based on a comparison of the utilization range and the specification; and
a control plane coupled to the cloud region to adjust the computing resources of the cloud region for providing the virtual desktop based on the updated specification.

2. The system of claim 1 wherein the specification includes a set of dimensions including at least one of number of CPU cores; RAM memory, disk size, disk class, and presence of a Graphical Processing Unit (GPU).

3. The system of claim 2, wherein the performance analysis service compares each dimension of the specification with associated data from the collected usage data over a period of usage of the desktop.

4. The system of claim 3, wherein the performance analysis service produces a utilization scorecard including an indication of over-utilization or under-utilization of at least one dimension.

5. The system of claim 1, wherein the usage data is collected periodically over a series of time points during the user using the virtual desktop.

6. The system of claim 3, wherein thresholds are determined for over-utilization and under-utilization.

7. The system of claim 1, wherein the performance analysis service updates the specification to reduce resources for a dimension that is under-utilized.

8. The system of claim 1, wherein the performance analysis service updates the specification to increase computing resources for a dimension that is over-utilized.

9. The system of claim 1, wherein the control plane is operable to change computing resources while the user is using the virtual desktop.

10. The system of claim 1, wherein the adjustment of the computing resources is based on a pre-determined rule.

11. The system of claim 1, wherein the control plane provides a desktop according to the updated specification from another cloud region providing the computing resources to meet the updated specification.

12. The system of claim 1, wherein the cloud region includes a desktop agent monitoring the use of the virtual desktop, and wherein the collected operational data is provided by the desktop agent.

13. A method for managing computing resources for provision of a virtual desktop from a cloud region, the method comprising:
providing a specification of computing resources to provide the virtual desktop to a client device of a user;
collecting operational data from use of the virtual desktop by the user:
analyzing use of the computing resources of the virtual desktop according to utilization ranges relative to the specification;
updating the specification for the virtual desktop based on a comparison of the utilization range and the specification; and
adjusting the computing resources of the cloud region for providing the virtual desktop based on the updated specification.

14. The method of claim 13 wherein the specification includes a set of dimensions including at least one of number of CPU cores; RAM memory, disk size, disk class, and presence of a Graphical Processing Unit (GPU).

15. The method of claim 14, wherein analyzing use includes producing a utilization scorecard including an indication of over-utilization or under-utilization of at least one of the set of dimensions.

16. The method of claim 13, wherein the usage data is collected periodically over a series of time points during the user using the virtual desktop.

17. The method of claim 15, further comprising determining thresholds for over-utilization and under-utilization.

18. The method of claim 17, wherein the specification is updated to reduce resources for a dimension that is under-utilized and increasing computing resources for a dimension that is over-utilized.

19. The method of claim 13, wherein a control plane provides a desktop according to the updated specification from another cloud region providing the computing resources to meet the updated specification.

20. A non-transitory computer-readable medium having machine-readable instructions stored thereon, which when executed by a processor, cause the processor to:
store a specification of computing resources to provide the virtual desktop to a client device of a user;
collect operational data from use of the virtual desktop by the user:
analyze use of the computing resources of the virtual desktop according to utilization ranges relative to the specification;
update the specification for the virtual desktop based on a comparison of the utilization range and the specification; and
adjust the computing resources of the cloud region for providing the virtual desktop based on the updated specification.
